(19) United States
(12) Patent Application Publication
(10) Pub. No.: US 2025/0043717 A1
(43) Pub. Date: Feb. 6, 2025

(54) INSTALLATION WITH INSTANTANEOUS STEAM GENERATOR

(71) Applicant: Siemens Energy Global GmbH & Co. KG, Munich, Bayern (DE)

(72) Inventors: Stefan Brück, Mulheim an der Ruhr (DE); Carmen Stüer, Haltern Hullern (DE)

(73) Assignee: Siemens Energy Global GmbH & Co. KG, Munich, Bayern (DE)

(21) Appl. No.: 18/718,038

(22) PCT Filed: Nov. 16, 2022
(86) PCT No.: PCT/EP2022/082066

§ 371 Date: Jun. 9, 2024

(30) Foreign Application Priority Data
Dec. 17, 2021 (EP) 21215623.6

(51) Int. Cl. F02C 3/22; F01K 11/02; F22B 1/00; F22B 35/00

(52) U.S. Cl. CPC F02C 3/22; F01K 11/02; F22B 1/003; F22B 35/005

(57) ABSTRACT

An installation includes a steam generator and a steam load, wherein the steam load requires a first steam quantity in a normal mode and a second larger steam quantity in the event of a fault, and steam is instantaneously generated by an instantaneous steam generator in order to provide the second steam quantity.

### CROSS REFERENCE TO RELATED APPLICATIONS

This application is the US National Stage of International Application No. PCT/EP2022/082066 filed 16-11-2022, and claims the benefit thereof, which is incorporated by reference herein in its entirety. The International Application claims the benefit of European Application No. EP21215623 filed 17-12-2021.

### FIELD OF INVENTION

The invention relates to a system comprising a steam generator and a steam consumer, wherein an outlet of the steam generator is fluidically connected to an inlet of the steam consumer.

The invention furthermore relates to a method for operating an installation, wherein the installation is formed with a steam generator and a steam consumer, wherein the steam generator generates steam for the steam consumer, wherein the steam consumer is designed for a first operating state with a first steam flow rate and for a second operating state with a second steam flow rate, wherein the second steam flow rate is higher than the first steam flow rate.

The invention furthermore relates to a method for retrofitting an existing steam consumer installation having a steam generator and a steam consumer, wherein steam for the steam consumer is generated by the steam generator, wherein the steam consumer requires a first steam flow rate in a first operating state and requires a second steam flow rate in a second operating state, wherein the second steam flow rate is higher than the first steam flow rate, wherein the steam generator can generate the second steam flow rate when operated at full load, and wherein a steam turbine is provided which is impinged on by steam that is not required by the steam consumer.

### BACKGROUND OF INVENTION

Installations exist in which a steam generator generates steam for a steam consumer. In these installations, in which industrial processes are performed, it is common for steam to be used as a working medium or for heat supply purposes. Owing to the thermal properties of water, most steam generators are however relatively inert systems, i.e. changes to steam or heat flow rates are possible only relatively slowly.

In a process, events may occur in the case of which a high steam and/or heat flow rate is required. This is necessary for example in a fault situation.

Here, the installations are operated such that the increased steam flow rate required for the event is generated permanently by the steam generator. In other words, the installation is operated in a state in which excess steam is produced.

Here, the installations are operated such that, by way of precaution, the steam generator permanently generates an excess flow rate that is suitable for a fault situation.

The steam flow rate that is required for the event, for example the fault situation, is then in most cases, during normal operation, expanded in a steam turbine that is then used for example to generate electrical energy.

If the event occurs, the steam flow rate in the steam turbine can be reduced accordingly by means of a control element, for example valve, which is arranged upstream of the steam turbine. Steam can thus be made available, which is then for a short time conducted as process steam to the steam consumer.

Permanent additional combustion of fossil fuels has hitherto been necessary in order to achieve the overproduction of steam. The overproduction of steam may be achieved for example by means of a fossil-fuel-powered steam generator, a waste heat boiler, an electrical superheater or a fuel cell.

This excess has hitherto been not discarded but converted, for example into electrical energy, in most cases. From an economical aspect, however, the electrical energy thus generated is in most cases not cost-effective.

With the expansion of renewable energies, the increase in CO2 prices etc., it is to be expected that this will be further exacerbated in future.

### SUMMARY OF INVENTION

Proceeding from the known problems and disadvantages of the prior art, it is an object of the invention to specify an installation and a method with which a cost advantage can be achieved.

The object is directed to a device, a method, and a method for retrofitting achieved by means of the independent claims. The subclaims which are dependent on and refer back thereto relate to advantageous refinements the invention.

An essential feature of the invention is the use of an instantaneous steam generator. This instantaneous steam generator, which can also be referred to as a steam booster, is designed to generate steam, wherein the steam flow rate generated in the instantaneous steam generator can be generated very much more quickly than that generated in the steam generator. For this purpose, use is made, for example, of an instantaneous steam generator that generates steam and thermal energy through the combustion of hydrogen. During the combustion of hydrogen, a chemical reaction takes place in which hydrogen and oxygen react with one another, with water vapor and thermal energy being generated after the chemical reaction.

The invention is furthermore based on the concept that constant overproduction of steam can be eliminated, and the instantaneous steam generator provides the increased flow rate of steam when required. It is optionally possible for the steam generator to be operated at part load during normal operation and to then achieve the increased flow rate at full load in a fault situation. Once full load has been reached, the steam generator can provide the increased steam flow rate, and the instantaneous steam generator can subsequently be deactivated again.

With the direct combustion of hydrogen and oxygen, the phase transition (saturated steam range) is bypassed, such that very high flow rates of heat and/or steam at temperatures of up to >1300° can be generated very quickly. Since it is the case with direct combustion, by contrast to previous systems that are operated with fossil fuels, that the combustion product is the circuit medium itself, previously required heat exchangers are eliminated, thus making particularly fast load changes possible.

Through the use of direct combustion of hydrogen and oxygen to generate steam, permanent overproduction of steam can be eliminated or at least greatly reduced. The energy requirement of the systems, and at the same time the use of fossil fuels, can thus be greatly reduced. The process steam that is otherwise provided by way of the rapid reduction of the steam flow rate through the steam turbine is generated in this case through a direct combustion of hydrogen and oxygen.

The above-described properties, features and advantages of this invention, and the manner in which these are achieved, will become clearer and easier to understand in conjunction with the following description of the exemplary embodiments, which will be discussed in more detail in conjunction with the drawings.

Identical components or components of identical function are denoted by the same reference designations.

Exemplary embodiments of the invention will be described below on the basis of the drawings. The drawings are not intended to illustrate the exemplary embodiments to scale; rather, the drawings are of schematic and/or slightly distorted form where expedient for explanatory purposes. With regard to additions to the teaching that emerges directly from the drawing, reference is made to the relevant prior art.

### BRIEF DESCRIPTION OF THE DRAWINGS

In the drawings:

FIG. 1 is a schematic illustration of an installation according to the prior art; and

FIG. 2 is a schematic illustration of an installation according to the invention.

### DETAILED DESCRIPTION OF INVENTION

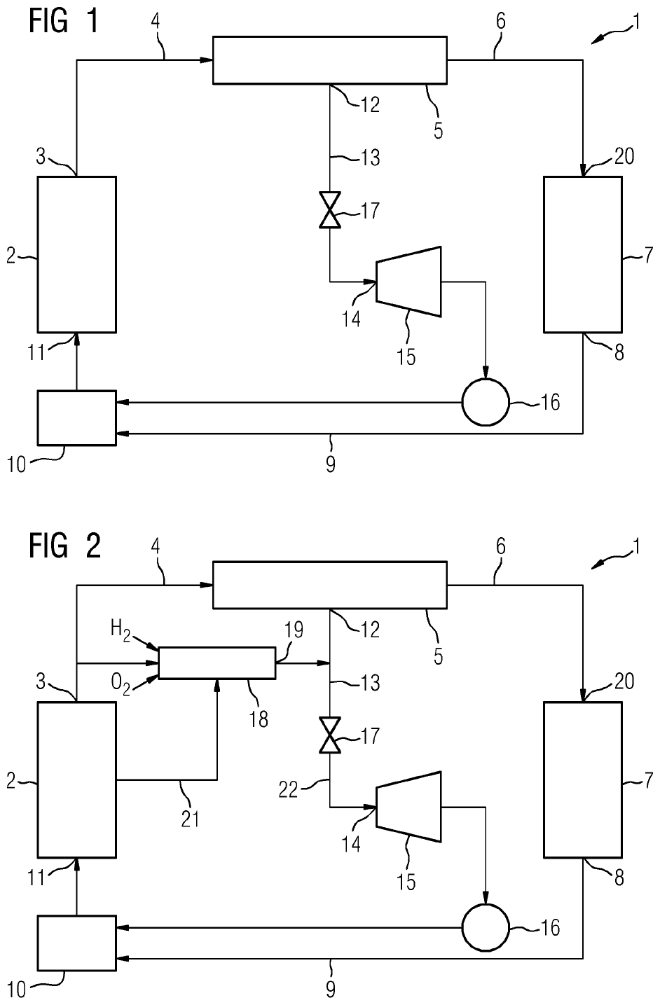

FIG. 1 shows an installation 1 according to the prior art. The installation 1 comprises a steam generator 2. The steam generator 2 is designed to generate steam. An outlet 3 of the steam generator 2 is fluidically connected via a first line 4 to a collecting rail 5. The steam situated in the collecting rail 5 is conducted via a second line 6 into a steam consumer 7.

An outlet 8 of the steam consumer 7 is fluidically connected via the third line 9 to a water tank 10. The water tank 10 is in turn fluidically connected to an inlet 11 of the steam generator 2.

The collecting rail 5 has a further outlet 12, which is fluidically connected via a fourth line 13 to an inlet 14 of a steam turbine 15. In the steam turbine 15, the thermal energy of the steam is converted into kinetic energy, wherein the kinetic energy can be converted into electrical energy by means of generators (not illustrated).

The steam flowing out of the steam turbine 15 is then converted into water again in a condenser 16. The water that is converted in the condenser 16 flows back into the steam generator 2 via the water tank 10.

The installation 1 according to the prior art functions as follows: The steam consumer 7 has at least two operating states. In the first operating state, the steam consumer 7 requires a first steam flow rate. In the second operating state, the steam consumer 7 requires a second steam flow rate. The second steam flow rate is higher than the first steam flow rate.

It cannot always be predicted when the installation 1, which during continuous operation is operated in the first operating state, will change to the second operating state. In general, the steam generator 2 is inert. This means that it takes a relatively long time to generate the second steam flow rate. However, in the second operating state, the second steam flow rate is required quickly. Therefore, the second steam flow rate that is required for the second operating state is already generated in the steam generator 2. The steam that is not required in the steam consumer 7 is conducted via the steam turbine 15.

The steam flow rate entering the steam turbine 15 can be controlled by means of a valve 17. Therefore, in the second operating state, the valve 17 is throttled, such that a greater steam flow rate is available for the steam consumer 7.

FIG. 2 now shows an improved installation 1 according to the invention. A difference between the installation 1 according to FIG. 2 and the installation 1 according to FIG. 1 is the provision of an instantaneous steam generator 18. The instantaneous steam generator 18 is designed to generate steam and thermal energy through the combustion of hydrogen. An outlet 19 of the instantaneous steam generator 18 is connected to the inlet 20 of the steam consumer 7. In alternative embodiments, steam is extracted from the steam turbine 15.

The steam generator 2 can be operated to generate steam for the first operating state and for the second operating state, whilst the instantaneous steam generator 18 is designed to generate steam for the second operating state.

Steam is provided by the instantaneous steam generator 18 relatively quickly. In the instantaneous steam generator, a chemical reaction takes place between hydrogen and oxygen, with water vapor and thermal energy being generated.

As in FIG. 1, the steam generator 2 is configured for part load in the first operating state and for full load in the second operating state.

The installation 1 according to the invention as per FIG. 2 is operated as follows: During continuous operation or nominal operation, the steam generator 2 is operated at part load and delivers the first steam flow rate that is required by the steam consumer. This is the first operating state.

A proportion of the steam flow rate can be branched off via the steam turbine 15, and electrical energy can thereby be generated.

In the second operating state, the steam consumer 7 requires the second steam flow rate. At a first point in time in the second operating state, the second steam flow rate is generated by the steam generator 2 and the instantaneous steam generator 18. Steam is generated by the instantaneous steam generator 18 relatively quickly. At the same time, the steam generator 2 is switched from part load to full load, such that the steam generator 2 generates an increasing amount of steam.

As soon as the second steam flow rate is being generated by the steam generator 2 on its own, the instantaneous steam generator 18 is deactivated again. Accordingly, at a second point in time in the second operating state, the second steam flow rate is generated by the steam generator 2 without the instantaneous steam generator 18.

The steam flow rate entering the steam turbine 15 is controlled by means of the valve 17. Altogether, therefore, the steam flow rate entering the steam consumer 7 can be controlled by means of the steam turbine 15.

In an alternative embodiment, a water line 21 may lead from the steam generator 2 to the instantaneous steam generator 18. The water that is conducted out of said water line 21 can be converted into steam by the thermal energy that is generated in the instantaneous steam generator 18. An even higher steam flow rate can thus be quickly and easily provided.

The concept according to the invention is suitable for the retrofitting of existing installations in which a first and a second steam flow rate are required in a steam consumer 7. For this purpose, the instantaneous steam generator 18 must additionally be installed into an existing installation. The existing components such as the steam generator 2 or the steam turbine 15 generally do not need to be exchanged. As a result of this retrofitting, the control strategy of the steam generator 2 is changed, leading to a cost saving.

1. An installation, comprising:
a steam generator and a steam consumer, wherein an outlet of the steam generator is fluidically connected to an inlet of the steam consumer,
an instantaneous steam generator which generates steam through combustion of hydrogen, wherein an outlet of the instantaneous steam generator is connected to the inlet of the steam consumer,
wherein the steam consumer is designed for a first steam flow rate in a first operating state and for a second steam flow rate in a second operating state,
wherein the second steam flow rate is higher than the first steam flow rate,
wherein the steam generator is operable to generate steam for the first operating state and the second operating state,
wherein the instantaneous steam generator is designed to generate steam for the second operating state, wherein the first operating state is configured as part load and the second operating state is configured as full load for the steam generator,
wherein, in the first operating state, the first steam flow rate is generated by the steam generator,
wherein, at a first point in time in the second operating state, the second steam flow rate is generated by the steam generator and the instantaneous steam generator,
wherein, at a second point in time in the second operating state, the second steam flow rate is generated by the steam generator without the instantaneous steam generator.

2. The installation as claimed in claim 1, further comprising:
a steam turbine, wherein the inlet of the steam turbine is fluidically connected to an outlet of the steam generator and of the instantaneous steam generator via a steam line.

3. The installation as claimed in claim 2,
wherein the outlet of the steam turbine is fluidically connected to the inlet of a condenser,
wherein the outlet of the condenser is fluidically connected to the inlet of the steam generator.

4. The installation as claimed in claim 2,
wherein the outlet of the steam consumer is connected to the inlet of the steam generator.

5. The installation as claimed in claim 2,
wherein a valve is arranged in the steam line, wherein the steam flow rate to the steam consumer is controllable by the valve.

6. The installation as claimed in claim 1,
wherein the instantaneous steam generator is connected to a water line, and the instantaneous steam generator is designed such that water from the water line is convertible into steam through generation of thermal energy in the instantaneous steam generator.

7. A method for operating an installation, wherein the installation is formed with a steam generator and a steam consumer, wherein the steam generator generates steam for the steam consumer, wherein the steam consumer is designed for a first operating state with a first steam flow rate and for a second operating state with a second steam flow rate, wherein the second steam flow rate is higher than the first steam flow rate, wherein an instantaneous steam generator is used, which generates steam for the steam consumer through combustion of hydrogen, the method comprising:
generating the steam for the first operating state by the steam generator,
upon a change from the first operating state to the second operating state, generating the steam for the steam consumer by the steam generator and the instantaneous steam generator,
wherein, in the first operating state, the steam generator is operated at part load,
wherein, in the second operating state, the steam generator is operated at full load,
wherein, until the steam generator has reached full load, the instantaneous steam generator generates steam for the second operating state,
wherein, after the steam generator has reached full load, the instantaneous steam generator is deactivated.

8. The method as claimed in claim 7,
wherein the installation is formed with a steam turbine, wherein the steam turbine is supplied with steam from the steam generator and from the instantaneous steam generator.

9. The method as claimed in claim 8,
wherein the steam flow rate into the steam turbine is controlled by a valve, wherein the valve is arranged upstream of an inlet of the steam turbine.

10. A method for retrofitting an existing steam consumer installation having a steam generator and a steam consumer, wherein steam for the steam consumer is generated by the steam generator, wherein the steam consumer requires a first steam flow rate in a first operating state and requires a second steam flow rate in a second operating state, wherein the second steam flow rate is higher than the first steam flow rate, wherein the steam generator can generate the second steam flow rate when operated at full load, and wherein a steam turbine is provided which is impinged on by steam that is not required by the steam consumer, the method comprising:
using an instantaneous steam generator to generate additional steam for the steam consumer.

11. The method as claimed in claim 10,
wherein, in the first operating state, the steam generator is operated at part load, and the instantaneous steam generator does not generate any steam.

12. The method as claimed in claim 10,
wherein, in the second operating state, the steam generator is operated at full load and the instantaneous steam generator generates steam for the steam consumer until such time as the steam generator, operating at full load, can generate the second steam flow rate.
